(19) United States
(12) Patent Application Publication
(10) Pub. No.: US 2015/0254432 A1
(43) Pub. Date: Sep. 10, 2015

(54) CLINICAL TRIAL ENGAGEMENT TOOL

(71) Applicant: TCN Technologies, LLC, Needham, MA (US)

(72) Inventors: Matthew K. Stumm, Framingham, MA (US); Aaron B. Fleishman, Hull, MA (US); Joan F. Bachenheimer, Hull, MA (US); Matthew L. Kibby, Sharon, MA (US)

(21) Appl. No.: 14/642,448

(22) Filed: Mar. 9, 2015

Related U.S. Application Data
(60) Provisional application No. 61/950,528, filed on Mar. 10, 2014.

(51) Int. Cl. G06F 19/00; G06Q 30/02; H04M 1/725

(52) U.S. Cl. CPC G06F 19/363; H04M 1/72519; G06Q 30/0267; G06Q 30/0269; G06Q 30/0207

(57) ABSTRACT

A clinical trial engagement tool and method execute on a mobile computing device. The tool includes displays of information containing pre-enrollment content based on searches executed on the mobile computing device, wherein access thereto is enabled without requirement of a user-specific login or security key. The tool includes displays containing clinical trial patient participation content, wherein access thereto is enabled only upon completion of a user authentication and authorization process. A tracking mechanism of the tool generates data that tracks which of the plurality of displays containing pre-enrollment content are accessed. The tool displays information containing notification content that is automatically selected for display based on the tracked data, thereby transforming the data into parameters that define which displays of notification content are automatically selected for display. The notification content includes information related to upcoming clinical trials having a potential to be of interest to the user of the device.

### REFERENCE TO RELATED APPLICATION

This application claims priority to, and the benefit of, co-pending U.S. Provisional Application No. 61/950,528, filed Mar. 10, 2014, for all subject matter common to both applications. The disclosure of said provisional application is hereby incorporated herein by reference in its entirety.

### FIELD OF THE INVENTION

The present invention relates to a clinical trial engagement tool, and more particularly to a prospective clinical trial patient participant, and/or clinical trial patient participant, engagement tool for execution on a mobile computing device enabling interaction with a prospective clinical trial patient participant through a variety of displays, and also enabling interaction with a clinical trial patient participant through a different variety of displays with constraints on access.

### BACKGROUND OF THE INVENTION

In carrying out clinical research for pharmaceuticals, medical devices, and biologics, there are many electronic data collection and operational support systems known as clinical trial management systems, patient recruitment management systems, or electronic data capture systems. Generally, in the patient recruitment process a company with a product, such as, but not limited to, a pharmaceutical company with a new drug, or a medical device company with a new medical device, has studies (e.g., trials) that require completion to a degree of regulatory satisfaction. The company contracts with investigational sites for the completion of the studies, while the investigational sites are responsible for recruiting patients, having the studies completed, and reporting results of the studies. Part of the conventional clinical trial process includes patient recruitment for prospective clinical trial patient participants (i.e., clinical trial candidates).

There are processes currently utilized to recruit or solicit clinical trial candidates. For example, advertisements have been used to solicit clinical trial candidates to participate in clinical trials such that the advertisement can be directed toward particular individuals that suffer from a disease or condition. In particular, an advertisement for clinical trial candidates can be taken out in any advertising medium (e.g., newspaper or magazine) where it lists clinical trial criteria (i.e., clinical trial requirements) for clinical trial patient participants. The advertisement invites clinical trial candidates who meet requirements (detailed in advertisement) to contact a particular clinical trial via phone or email to be considered to participate in the clinical trial. Through the Internet, there are unsecured websites that provide conventional solicitation or on-line recruitment of clinical trial candidates. However, these websites are not suitable for receiving any personal identifiable medical data concerning clinical trial candidates suffering from conditions or diseases. In addition, prospective patients are hesitant to give identifying information when they are simply researching different topics or conditions, which is often a requirement. However, the above-described technologies experience some shortcomings related to the ability to actively engage with users in both a pre-enrollment status and a post-enrollment status, and provide additional useful functionality that leverages activities of both types of users.

### SUMMARY

There is a need for a tool operating on a device, such as a mobile computing device application operating on a mobile hardware device, which provides targeted notification content (e.g., advertisements) based on tracking of displays accessed by the mobile computing device without requiring user-identifying information such as a login or password, security key, or other personal user-identifying information. In particular, the present invention provides a clinical trial engagement tool that can track access to content (pre-enrollment and/or post-enrollment) and display notification content based on this tracking. Thus, once the present invention tool is utilized by a user, the tool instantaneously tracks user's actions providing useful information or data to the tool with respect to targeted notification. In circumstances where a user has transitioned from a prospective clinical trial patient participant (i.e., at a pre-enrollment phase) to an active clinical trial patient participant (i.e., after enrolling in a clinical trial), the present inventive tool can draw from the data or information gathered from the clinical trial patient participant prior to enrolling in a clinical trial (i.e., when they are a prospective clinical trial patient participant), as well as when enrolled, as well as after the clinical trial has concluded. Thus, the present invention clinical trial engagement tool crosses between pre-enrollment and post enrollment phases and links these two worlds in a way that was previously not possible because in the pre-enrollment phase the activity of the user was not recorded or stored and the post-enrollment phase maintained patient information but did not have any access to patient's actions (e.g., researching diseases) prior to joining the trial. Implementation of the present invention at least results in a significant improvement in the technology and science of useful interaction with a prospective clinical trial patient participant and a further improvement in the ability to engage with the prospective clinical trial patient participant in a more focused and targeted manner that increases the likelihood of transforming the prospective clinical trial patient participant into an actual enrolled clinical trial patient participant.

Implementation of the present invention tool at least further results in continually updating and improving the technology of notification functions as updated data/information is received based on tracking of user activity with their mobile computing device. The present invention tool also provides a secure system for users to input private information related to their disease, condition, address, and biographical information (age, married, etc.). The present invention is directed toward further solutions to address these needs, in addition to having other desirable characteristics.

In accordance with an embodiment of the present invention, a clinical trial engagement tool is configured for execution on a mobile computing device. The clinical trial patient participant engagement tool is configured for interaction with a user and includes a plurality of displays of information containing pre-enrollment content. Access to the plurality of displays of information containing pre-enrollment content is provided without requirement of a user-specific login or security key and based on searches executed on the mobile computing device. The clinical trial engagement tool includes a plurality of displays containing clinical trial patient participation content. Access to the plurality of displays containing clinical trial patient participation content is provided only upon completion of a user authentication process and completion of a user authorization process. The clinical trial engagement tool includes a tracking mechanism that tracks which of the plurality of displays containing pre-enrollment content are accessed using the mobile computing device. The clinical trial engagement tool includes a plurality of displays of information containing notification content. The notification content is automatically selected for display based on which of the plurality of displays of information containing pre-enrollment content are accessed using the mobile computing device. The notification content includes information related to upcoming clinical trials having a potential to be of interest to the user of the mobile computing device. The potential to be of interest is determined based on which of the plurality of displays containing pre-enrollment content are tracked as having been accessed by the mobile computing device.

In accordance with aspects of the present invention, the tracking mechanism is configured to track which of the plurality of displays containing clinical trial patient participation content are accessed using the mobile computing device. The notification content is automatically selected for display based on which of the plurality of displays of information containing clinical trial patient participation content are accessed using the mobile computing device.

In accordance with aspects of the present invention, the plurality of displays of information containing pre-enrollment content comprise one or more displays of information content related to: available clinical trials, specific disease or condition research, one or more disease or condition themed community groups, one or more disease or condition themed organizations, one or more disease or condition themed social networks, and/or a guide on formation of a new disease or condition themed group.

In accordance with aspects of the present invention, the plurality of displays containing clinical trial patient participation content comprise one or more displays of information content related to: guidelines for participation in a specific clinical trial within which the user is enrolled, one or more doctors or clinical researchers associated with a specific clinical trial within which the user is enrolled, one or more treatment protocols associated with a specific clinical trial within which the user is enrolled, one or more disease or condition management tools associated with a specific clinical trial within which the user is enrolled, one or more health records of the user associated with a specific clinical trial within which the user is enrolled, a calendar of events associated with a specific clinical trial within which the user is enrolled, one or more medication reminders for the user associated with a specific clinical trial within which the user is enrolled, a private communication mechanism enabling the user associated with a specific clinical trial within which the user is enrolled to communicate with one or more clinical trial administrator, doctor, or care provider, clinical trial participant reimbursement system, and/or a clinical trial participant transportation system.

In accordance with aspects of the present invention, the tracking mechanism is implemented on the mobile computing device and/or the tracking mechanism is implemented on a cloud computing infrastructure in communication with the mobile computing device.

In accordance with one aspect of the present invention, the notification content is automatically selected for display based on which of the plurality of displays of information containing pre-enrollment content are accessed using the mobile computing device. This is determined by an advertising or marketing algorithm.

In accordance with one aspect of the present invention, the pre-enrollment content includes one or more of text, audio, still images, animation, video or interactive formats. In one aspect, the clinical trial patient participation content includes one or more of text, audio, still images, animation, video or interactive formats.

In accordance with one aspect of the present invention, the targeted notification content includes targeted advertising or marketing content.

In accordance with an embodiment of the present invention, a method of interacting with a user includes using a clinical trial engagement tool configured for execution on a mobile computing device. The clinical trial engagement tool executes on the mobile computing device. The clinical trial engagement tool displays one or more of a plurality of displays of information that contain pre-enrollment content. Access to the plurality of displays of information containing pre-enrollment content is provided without requirement of a user-specific login or security key and based on searches executed on the mobile computing device. The clinical trial engagement tool displays a plurality of displays containing clinical trial patient participation content. Access to the plurality of displays containing clinical trial patient participation content is provided only upon completion of a user authentication process and completion of a user authorization process. A tracking mechanism tracks which of the plurality of displays containing pre-enrollment content are accessed using the mobile computing device. The clinical trial engagement tool displays a plurality of displays of information containing targeted notification content. The targeted notification content is automatically selected for display based on which of the plurality of displays of information containing pre-enrollment content are accessed using the mobile computing device. The targeted notification content includes information related to upcoming clinical trials having a potential to be of interest to the user of the mobile computing device. The potential to be of interest is determined based on which of the plurality of displays containing pre-enrollment content are tracked as having been accessed by the mobile computing device. For example, a tracking mechanism record indicating that the device has accessed a plurality of displays relating to a particular health-related condition, or has accessed a plurality of displays relating to a particular clinical trial or number of clinical trials relating to a particular health condition, would be interpreted as the clinical trials topically related to that health-related condition having the potential to be of interest to the user of the mobile device.

### BRIEF DESCRIPTION OF THE FIGURES

These and other characteristics of the present invention will be more fully understood by reference to the following detailed description in conjunction with the attached drawings, in which:

FIG. 1 is a diagrammatic illustration of a clinical trial engagement tool, according to an embodiment of the present invention;

FIG. 2 is a flowchart illustrating a method of implementation of a clinical trial engagement tool, according to an embodiment of the present invention;

FIG. 3 is a schematic illustration of a mobile computing device utilizing the clinical trial engagement tool to display a starting menu for distinguishing types of users, according to one aspect of the present invention;

FIGS. 4A-4B are schematic illustrations of a mobile computing device utilizing the clinical trial engagement tool to display a menu of general information topics containing pre-enrollment content, according to aspects of the present invention;

FIGS. 5A-5C are schematic illustrations of a mobile computing device utilizing the clinical trial engagement tool to display clinical trial patient participation content, according to aspects of the present invention;

FIGS. 6A-6C are schematic illustrations of a mobile computing device utilizing the clinical trial engagement tool to display pre-enrollment content about available clinical trials, according to aspects of the present invention;

FIGS. 7A-7C are schematic illustrations of a mobile computing device utilizing the clinical trial engagement tool to display pre-enrollment content about specific disease or condition research, according to aspects of the present invention;

FIGS. 8A-8J are schematic illustrations of a mobile computing device utilizing the clinical trial engagement tool to display pre-enrollment content about disease or condition themed: community groups, organizations, events, social networks, and information, according to aspects of the present invention;

FIGS. 9A-9D are schematic illustrations of a mobile computing device utilizing the clinical trial engagement tool to display pre-enrollment content about other user tools/features such as favorites, glossary/facts, and sharing, according to aspects of the present invention;

FIGS. 10A-10D are schematic illustrations of a mobile computing device utilizing the clinical trial engagement tool to display notification content within other displays, according to aspects of the present invention; and

FIG. 11 is a schematic view of a computing device or system, suitable for implementing tools and methods of the present invention.

### DETAILED DESCRIPTION

An illustrative embodiment of the present invention relates to a clinical trial engagement tool. The clinical trial engagement tool is executed on a mobile computing device such as through a cloud computing infrastructure (i.e., provided as a mobile application). The clinical trial engagement tool interacts with a user through various types of displays that are particularly categorized based on two operating modes. The displays are categorized as including pre-enrollment content (first operating mode) or clinical trial patient participation content (second operating mode). Pre-enrollment content can be accessed based on searches executed by the user without requiring a user-specific login (i.e., no login or password or other security key or mechanism needed since they have not enrolled in clinical trial). However, clinical trial patient participation content is only accessed upon completion of a user authentication process and completion of a user authorization process (e.g., user is a clinical trial participant and has login/password, security key, or executes any conventional authentication and authorization processes). Thus, the clinical trial engagement tool is able to protect private clinical trial information by distinguishing between users and only allowing particular (e.g., those meeting one or more criteria related to the clinical trial) clinical trial patient participants access to specific clinical trial patient participation content. This specific clinical trial patient participation content can be distinguished further such that only the particular clinical patient participant can access/view their own personal information (e.g., personal medical information, address, phone number, etc.) and only the group of clinical trial patient participants enrolled in a particular clinical trial can access the general information for that particular clinical trial (e.g., reminders, notices, etc.).

The clinical trial engagement tool (e.g., mobile application) further includes a tracking mechanism that, using a processor, generates data that tracks user access to pre-enrollment content (i.e., prospective mode) and post-enrollment content (i.e., participant mode) via the mobile computing device. This means that the clinical trial engagement tool tracks which displays or screens (i.e., particular content) are accessed by the user. In particular, this tracking mechanism allows the same clinical trial engagement tool to track both pre-enrollment content and post-enrollment content (i.e., pre-enrollment and post-enrollment functionalities) by causing the storage of the information (i.e., pre-enrollment content or post-enrollment content) and leverage that tracking information of where the user had been to be used in identifying notification content that is likely to be of interest to the user in the future, thereby transforming the data into parameters that define which of the plurality of displays of information containing notification content should be automatically selected and then presented to the user. Thus, notification content can be automatically selected or identified and displayed based on which pre-enrollment and/or post-enrollment content was accessed using the mobile computing device. This notification content can include information related to particular upcoming clinical trials having a potential to be of interest to the user of the mobile computing device. Therefore, based on the tracking of user access to displays, the clinical trial engagement tool can provide notification content that is geared to the user and likely to be of interest to the user. For example, accessed displays can be an indication of a specific disease or condition (e.g., heart disease) the user is researching, whether the user is looking for support groups related to the specific disease or condition (e.g., heart disease), etc. Based on the tracking of these accessed displays, the clinical trial engagement tool can be used, for example, to “suggest” that the user consider enrolling or learning more about one or more particular clinical trial related to the specific disease or condition (e.g., heart disease). Said differently, a tracking mechanism record, i.e., data, indicating that the device has accessed a plurality of displays relating to a particular health-related condition, or has accessed a plurality of displays relating to a particular clinical trial or number of clinical trials relating to a particular health condition, would be interpreted as the clinical trials topically related to that health-related condition having the potential to be of interest to the user of the mobile device. Those of skill in the art will appreciate that numerous different methodologies can be utilized to intake the tracking data of the accessed displays, process that data, and output a determined topic having the “potential to be of interest” to the user of the mobile device, including a particular clinical trial or plurality of clinical trials, as well as other related information having the “potential to be of interest” to the user, such that the present invention is not limited to the specific illustrative embodiment described herein. What is relevant to the present invention is not the particular method of determining the “potential to be of interest”, but rather that given the unique combination of components and functionality provided by the present invention, a unique set of data can be tracked and caused to be stored by the tracking mechanism relating to the displays that are accessed by the mobile device as described herein, and that data can be leveraged to make certain prospective determinations of potential interest, using numerous different methodologies.

The present invention clinical trial engagement tool provides the feature of information being tracked in a way that crosses between pre-enrollment and post enrollment phases, thus linking these two worlds in a way that was previously not possible because in the pre-enrollment phase the activity of the user was not recorded (e.g., users preferred to remain anonymous on the Internet) and the post-enrollment phase had patient information but didn't have any access to the patient's actions (e.g., researching) prior to joining the trial. The present invention clinical trial engagement tool provides the ability to track users anonymously during the pre-enrollment phase and then bridge this pre-enrollment tracking data to the same user during post-enrollment phase (i.e., user has joined or enrolled in clinical trial), enabling transformation of that data into useful functionality, including parameters for selecting notification content for display to the user that has substantially more targeted and customized relevance to that user based on their actual searching activity. The present invention thereby substantially advances at least the technical field of notifications and targeted advertising or marketing conveyed by notifications by making them more relevant to the user for whom they are selected and displayed.

As a central repository for data from multiple points such as, but not limited to, call centers, Clinical Trial Management Systems (CTMS), interactive voice response systems (IVRS), and study sites, the present clinical trial engagement tool and method tracks individual prospective clinical trial patient participants from original inquiry through and during clinical trial. The present clinical trial engagement tool and method provides clinical trial sponsors with operational data and infrastructure needed to immediately and cost effectively establish situational awareness, and to anticipate recruitment needs and rapidly react to enrollment shortfalls. The present clinical trial engagement tool and method can be provided by a Web-based application for gathering, managing, and analyzing recruitment activities and related metrics. The following description assumes that the present clinical trial engagement tool and method is provided by a Web-based application or cloud-computing infrastructure, both of which are facilitated on computer hardware devices. It should be noted that the clinical trial engagement tool and method may also be provided in an environment that is not Web-based, such as but not limited to an intranet environment within a hospital or university campus.

The clinical trial engagement tool of the invention can be implemented in software (e.g., firmware) operating on computing hardware, customized or dedicated hardware, or a combination thereof. In the currently contemplated example, the clinical trial engagement tool is implemented in software (e.g., mobile application via cloud computing), as an executable program, and is executed by a special or general purpose digital computer hardware device, such as a personal computer or desktop (PC; IBM-compatible, Apple-compatible, or otherwise), workstation, server, minicomputer, mainframe computer, laptop, mobile device, tablet computer, smart phone, wearable computing device, or other computing devices, as would be understood by those of skill in the art. Specifically, the clinical trial engagement tool, as provided by the computer, may be accessible via a Web site, through which users using the clinical trial engagement tool may interact. It should be noted that the embodiments described herein make reference to the computing device being a mobile computing device as that is the most likely example implementation; however, the present invention is anticipated for use by any such computing device or computing hardware that can serve the functional equivalent to the system and method described herein.

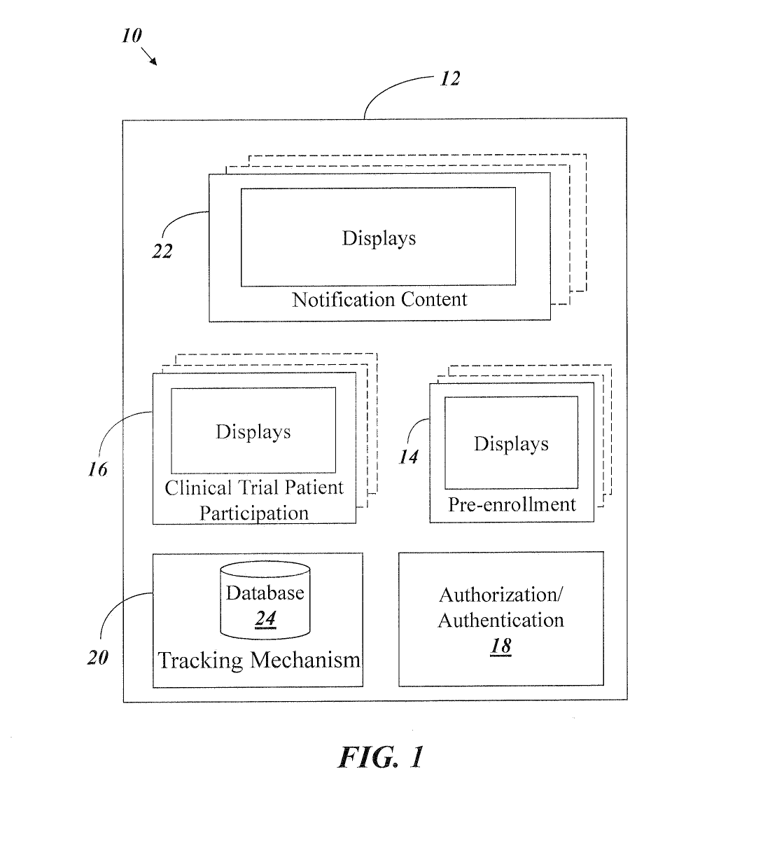

FIGS. 1 through 11, wherein like parts are designated by like reference numerals throughout, illustrate clinical trial engagement tool according to the present invention. Although the present invention will be described with reference to the figures, it should be understood that many alternative forms can embody the present invention. One of skill in the art will additionally appreciate different ways to alter the parameters disclosed, such as the type of elements in a manner still in keeping with the spirit and scope of the present invention.

FIG. 1 depicts a clinical trial engagement tool 10. It should be noted that communication with the clinical trial engagement tool 10 can be provided by multiple means such as, but not limited to, the Internet. Further description with regard to use of the clinical trial engagement tool 10 is provided below.

In accordance with an embodiment of the present invention, the clinical trial engagement tool 10 is configured for execution as a mobile application on a computer hardware device with a processor, such as a mobile computing device 12 (e.g., single install) which enables interaction with a user. The clinical trial engagement tool 10 includes pre-enrollment displays 14 on a display screen of the mobile computing device 12 having pre-enrollment content (i.e., content displayed to users that do not need to be enrolled in a clinical trial to access the content). These pre-enrollment displays 14 having pre-enrollment content can additionally be accessed by users that are actively enrolled in a clinical trial (i.e., clinical trial patient participants).

Unenrolled users (e.g., prospective clinical trial patient participants) are identified or viewed anonymously by the clinical trial engagement tool 10 such as based on an IP address, cookies, anonymous identifier, or other device-identifying information (not user identifying information) obtained from the mobile computing device 12. To maintain this anonymity, access to the pre-enrollment displays 14 is provided by the clinical trial engagement tool 10 without requirement of a user-specific login (i.e., there is no authentication or authorization process required for prospective clinical trial patient participants) or any other identifying information. The content of the pre-enrollment display 14 can be based on searches executed on the mobile computing device 12 or other queries that provide basic information (e.g., medical or health information) that is of interest to a user. Thus, users that are generally interested in health related information can utilize the clinical trial engagement tool 10 anonymously without having to be in a clinical trial or having to provide a username/password, security key, or other form of authentication or authorization. The anonymity feature (i.e., no required identifying information from users) of the clinical trial engagement tool 10 enables users to comfortably search for and view information (i.e. pre-enrollment content) without tying these searches to a user-identifying login/password or security key, thus maintaining their privacy. For example, this is particularly useful for users that are sensitive to anyone gaining knowledge of their interest in this information (e.g., health information related to particular disease or condition).

Enrolled users (e.g., clinical trial patient participants) can be identified or viewed as identifiable patients in a specific clinical trial by the clinical trial engagement tool 10. A user is identified as a clinical trial patient participant or identifiable patient based on authorization and authentication processing. In particular, an authorization/authentication module 18 requests the user to input certain required information for processing. The authorization/authentication module 18 can determine that the user requesting access to the clinical trial patient participation displays 16 is an authenticated clinical trial patient participant based on input of a username/password, a clinical trial code, a security key, and/or other authentication protocols or procedures as would be understood by those of skill in the art. The authorization/authentication module 18 can additionally determine whether the authenticated clinical trial patient participant is authorized to access clinical trial patient participation displays 16 related to a particular clinical trial based on the user's biographical profile, or login (username/password), security key, and/or other inputted information according to authorization protocols or procedures as would be understood by those of skill in the art. Once the user has been identified as an authenticated and authorized clinical trial patient participant, the clinical trial engagement tool 10 can provide clinical trial patient participation displays 16 having clinical trial patient participation content (e.g., content displayed to users that are recognized by the clinical trial engagement tool 10 as enrolled in a clinical trial). Access to the clinical trial patient participation displays 16 is provided only upon completion of the user authentication process and completion of the user authorization process via the authorization/authentication module 18. In one example, the clinical trial engagement tool 10 can define and identify a clinical trial patient participant as either a user actively enrolled in a clinical trial or a user previously enrolled in a clinical trial (via the authorization/authentication module 18). Alternatively, the clinical trial engagement tool 10 can identify only actively enrolled users as clinical trial patient participants. In a further example, the clinical trial engagement tool 10 can distinguish clinical trial patient participants with respect to geography or location, such as a particular country. This enables the clinical trial engagement tool 10, for example via remote authorization/authentication processes, to restrict or limit clinical trial patient participation content provided to users based on location such that certain content may not be disclosed in one country but can be disclosed in another country (e.g., content rules in Germany may differ from the US).

The clinical trial patient participation displays 16 can be distinguished further based on authorization. For example, the clinical trial engagement tool 10 can be configured in such a way that only the clinical patient participant can access/view their own personal information (e.g., personal medical information, address, phone number, etc.). Thus, clinical trial patient participation displays 16 categorized as having this type of personal information can only be authorized (via the authorization/authentication module 18) to the particular clinical patient participant. Clinical trial patient participation displays 16 can include displays 16 having information intended for the group of clinical trial patient participants enrolled in a particular clinical trial. Thus, clinical trial patient participation displays 16 categorized as intended for a particular clinical trial can only be authorized (via the authorization/authentication module 18) to the particular group of clinical patient participants in that clinical trial. For example, this allows the clinical trial engagement tool 10 to communicate, using clinical trial patient participation displays 16 (e.g., uniform messaging), with the group of clinical patient participants in a particular clinical trial a clinical trial. More generally, the clinical trial patient participation displays 16 can include displays that can be viewed by any and all users enrolled in a clinical trial (i.e., all clinical patient participants). Thus, these general clinical trial patient participation displays 16 (e.g., displays including user-group general information or user-specific general information) can be accessed/viewed (i.e., authorized) for any clinical patient participant. In another example, clinical trial patient participation displays 16 (i.e., clinical trial patient participation content) can be distinguished with respect to milestones such that a particular clinical patient participant can receive reminders or notices that relate to and are based on particular moments or milestones (e.g., visits, required phone calls, diary completion dates, etc.) that the particular clinical patient participant reaches within the study. For example, clinical patient participants may hit their milestones on different dates/times based on various aspects with a specific clinical trial (e.g., time of visit, required to fast, required lab tests, length of visit, etc.). Thus, receiving access to these particular clinical trial patient participation displays 16 (e.g., reminders or notices based on milestones) can vary in scope and time between different clinical patient participants.

Users identified as clinical trial patient participants can additionally access the pre-enrollment displays 14 described above. In one example, when accessing the pre-enrollment displays 14, the clinical trial patient participant is identified by the clinical trial engagement tool 10 as corresponding with a patient profile in a specific clinical trial. In another example, the clinical trial patient participant is identified by the clinical trial engagement tool 10 as an anonymous user recognized by an IP address, cookies, anonymous identifier, or other identifying information obtained from the mobile computing device 12. In a further example, the clinical trial patient participant is identified by the clinical trial engagement tool 10 as an anonymous user that is recognized by identifying information obtained from the mobile computing device 12 which is linked separately to a patient profile corresponding with the clinical trial patient participant. In another example, each clinical trial patient participant can be recognized as part of a particular group of clinical trial patient participants within a specific clinical trial.

When a clinical trial has completed (i.e., post clinical trial phase), the clinical trial engagement tool 10 can either continue to recognize the user as a clinical trial patient participant (user previously enrolled in a clinical trial) or the clinical trial engagement tool 10 can identify or view the user anonymously as an unenrolled user. For example, a user that completes a clinical trial may be interested in continuing to learn about the results of the completed clinical trial or study. Thus, the user, although not actively enrolled, is identified as a clinical trial patient participant with authorized access to clinical trial patient participation displays 16 with respect to their previous clinical trial. For example, this user can access clinical trial patient participation displays 16 that include particular reports and research related to the progress/results of their previously completed clinical trial. As described above, this user can always access pre-enrollment displays 14 (e.g., information about other studies or research about specific diseases/conditions). In another example where the user is no longer recognized as a clinical trial patient participant (i.e., viewed as unenrolled) due to completion of clinical trial, the user is no longer authorized to access clinical trial patient participation displays 16. Those of skill in the art will appreciate that the clinical trial engagement tool 10 can be configured in a number of different ways, variously combined, to result in the desired handling of a user and whether they are linked to an authorization or authentication process or not, following a time period when they have been previously classified or identified as an active clinical trial patient participant having provided personal information and followed an authentication/authorization process. All such various combinations of how information is shared, accessed, stored, and bridged between the different forms of enrollment status are anticipated by, and considered to form a part of, the present invention.

The clinical trial engagement tool 10 includes a tracking mechanism 20 configured for tracking which of the pre-enrollment displays 14 are accessed using the mobile computing device 12. The tracking mechanism 20 can also track which of the clinical trial patient participation displays 16 are accessed using the mobile computing device 12. The tracking mechanism 20 can be implemented on the mobile computing device 12 or implemented on a separate cloud computing infrastructure in communication with the mobile computing device 12. In particular, the tracking mechanism 20 can include, or have access to, a database 24 or storage device (on the mobile computing device 12 and/or remote in the separate cloud computing infrastructure) for storing a history of displays 14, 16 accessed by the user and provide such information to later processes implemented by the clinical trial engagement tool 10 for purposes of mining or leveraging such information and data.

Since prospective clinical trial patient participants (i.e., unenrolled users) are identified by the clinical trial engagement tool 10 anonymously, the tracking mechanism 20 tracks the pre-enrollment displays 14 accessed by prospective clinical trial patient participants via an anonymous identifier (e.g., IP address, cookies, or other identifying information obtained from the mobile computing device 12). This anonymous tracking of prospective clinical trial patient participants enables the clinical trial engagement tool 10 to follow the actions of users without any knowledge of the user's identity. When the user enrolls in a clinical trial, as described above, the clinical trial engagement tool 10 can recognize the user as a particular clinical trial patient participant (via the authorization/authentication module 18).

Despite a user's status change from prospective clinical trial patient participants to a clinical trial patient participant, the tracking mechanism 20 maintains access to the anonymous tracked activity of the user prior to enrolling a clinical trial. Thus, this allows the clinical trial engagement tool 10 to not only tie the two worlds (i.e., pre-enrollment phase and post enrollment phase) together but allows for identification of particular traits and characteristics of the pre-enrollment anonymous user (i.e., prospective clinical trial patient participant). For example, tracking mechanism 20 can track and record data as to what specific displays an anonymous user reviewed and how long they were on them, and further track and record data which anonymous users were motivated to move ahead with joining a clinical trial. Thus, for example, a combination of the types of displays reviewed along with personal information shared with the trial by the user allow for determining identifying traits and characteristics along with similar interests of prospective clinical trial patient participants that are more likely to join clinical trials. Other combinations of stored data containing tracked information used to determine traits and characteristics (i.e., relevant insights of clinical trial patient participants) corresponding with enrolling in certain clinical trials may be appreciated by one of skill in the art. Furthermore, the tracking mechanism 20 continues to track as well as have access to previous tracking data for a user that has completed a clinical trial (i.e., tying together pre-enrollment phase, post enrollment phase, and post clinical trial phase) whether or not the user is identified as clinical trial patient participant or anonymously.

Furthermore, the tracking mechanism 20 can continue to track and cause the storage of data pertaining to a clinical trial patient participant's activity and access with respect to clinical trial patient participation displays 16. Access to clinical trial patient participation displays 16 can be tracked directly to the participant's patient profile to provide the tracking mechanism 20 with additional data regarding the clinical trial patient participant's activity and interests. When the clinical trial patient participant accesses pre-enrollment displays 14, the tracking mechanism 20 can track these actions directly to the clinical trial patient participant (e.g., corresponding patient profile) or alternatively track these actions anonymously (e.g., IP address, cookies, anonymous identifier, or other identifying information obtained from mobile computing device 12). In a further example, anonymous tracking of the clinical trial patient participant's access to pre-enrollment displays 14 can be linked separately to the clinical trial patient participant (e.g., patient profile). Clinical trial patient participants can be tracked individually and/or as part of a group of clinical trial patient participants enrolled in a particular clinical trial. Other forms of tracking may be apparent to one of skill in the art with the benefit of the present application, and such forms of tracking are anticipated for use in conjunction with the present invention.

In one example, the data received by the tracking mechanism 20 can be used by clinical trial sponsors for monitoring with respect to clinical trial patient participant withdrawals. In particular, based on determined similar interests and/or similar movements by users that have withdrawn from clinical trials, clinical trial sponsors can anticipate withdrawals (e.g., drop-out due to lack of follow-up) in selecting future participants and improve clinical trial sponsor's interactions with clinical trial patient participants. In particular, a clinical trial sponsor can use this tracking information to act swiftly to a situation, based on tracking, to prevent future withdrawal. Thus, the clinical trial engagement tool 10 further contributes to reducing loss of prospective clinical trial patient participants due to follow-up issues since the clinical trial engagement tool 10 can stay connected with users even if they move to another address, for example. Other uses of the data and information tracked and stored according to the description here are likewise anticipated for use in conjunction with the present invention, as would be appreciated by those of skill in the art.

The clinical trial engagement tool 10 provides notification displays 22 that include information containing notification content (e.g., information about certain upcoming clinical trials or research, advertisements, etc.). The notification displays 22 are automatically selected based at least in part on which of the pre-enrollment displays 14 and/or clinical trial patient participation displays 16 have been accessed using the mobile computing device 12. In particular, the notification displays 22 are tied directly to the tracking mechanism 20, such that based on the data recovered from a particular user, certain notification displays 22 can be provided to the particular user and/or certain users are determined to be worthwhile targeting with notification displays 22.

Thus, even though a user is identified anonymously during the pre-enrollment phase, the clinical trial engagement tool 10 is able to track the pre-enrollment activity anonymously and continue to link it to tracking the user's post-enrollment activity (i.e., tracking patient/enrolled activity) and transform the data to provide a robust set of notification displays 22 (e.g., notifications, advertisements, or recommendations for research information), thereby substantially improving at least the technical field of advertising and marketing via notifications to users by providing notifications containing content that is substantially more customized, targeted, and relevant to the user based on the data collected. This connection between pre-enrollment and post-enrollment by the clinical trial engagement tool 10 can be additionally beneficial to a user with respect to the notification displays 22. For example, a user that is currently enrolled in a clinical trial relating to heart disease may have spent a significant amount of time researching symptoms that relate to a different form of vascular disease during the pre-enrollment phase. The clinical trial engagement tool 10 utilizing the tracking mechanism 20 can make a recommendation (i.e., notification via notification displays 22) for a different or additional clinical trial related to vascular disease. Those of skill in the art will appreciate that the tracking information data collected by the system and method of the present invention can be separately analyzed and mined for a plethora of different purposes and determinations, such as but not limited to this example.

The notification content in the notification displays 22 can include information related to upcoming clinical trials having a potential to be of interest to the user of the mobile computing device 12. The potential to be of interest is determined based at least in part on which of the displays 14, 16 are tracked as having been accessed by the mobile computing device 12. In one example, the targeted notification content can include targeted advertising or marketing content with respect to clinical trial sponsors. The targeted advertising or marketing content can include target market research type questions or other types of offers used to invite or attract prospective clinical trial patient participants into joining a particular clinical trial, as well as other advertising or marketing related content, as would be appreciated by those of skill in the art. The targeted notification content can be determined by an advertising or marketing algorithm. For example, the advertising or marketing algorithm can use the tracking information data, obtained and stored by the tracking mechanism 20, to determine which clinical trials are most likely to be of interest to the user, and then provide to the user notification displays 22 describing such clinical trials in advertisement form, thereby transforming the data into the improved notification displays 22 containing more relevant information. In one example, such tracking/notification functionality can be plugged in from a provider of an advertising serving company. The “intelligence” of the advertising algorithm is defined based on certain match criteria related to each clinical trial. This can be incorporated via a plug-in. For example, the clinical trial engagement tool 10 can work in conjunction with its own advertising or marketing algorithm, and/or an external algorithm, such as Google AdSense offered by Google, Inc., or other similar services. Category-targeted, placement-targeted, and remarketing ads from Google certified ad networks are eligible to appear via the notification displays 22, in addition to any push messages or other advertising or marketing originating with the clinical trial engagement tool 10 relating to the studies or projects of the clinical trials.

In addition, the notification displays 22 and the clinical trial engagement tool 10 in general can also access and interact with other functionalities within the mobile computing device 12. For example, the clinical trial engagement tool 10 can share content with other applications or features of the user's mobile computing device 12, such as for example, if there is a push message via the notification displays 22 relating to an upcoming clinical trial related appointment, the clinical trial engagement tool 10 will also store the appointment information in a calendar application of the mobile computing device 12, as well as send the appointment information to an external cloud based calendar, if desired by the user. Similar sharing and interaction can occur with entails, contact information, addresses, telephone numbers, and the like, such that when such information is present within or accessible by the clinical trial engagement tool 10, the clinical trial engagement tool 10 can also be configured to update calendars, phone books, contacts, mapping programs, and the like that are managed by or otherwise accessible and updatable via the mobile computing device 12.

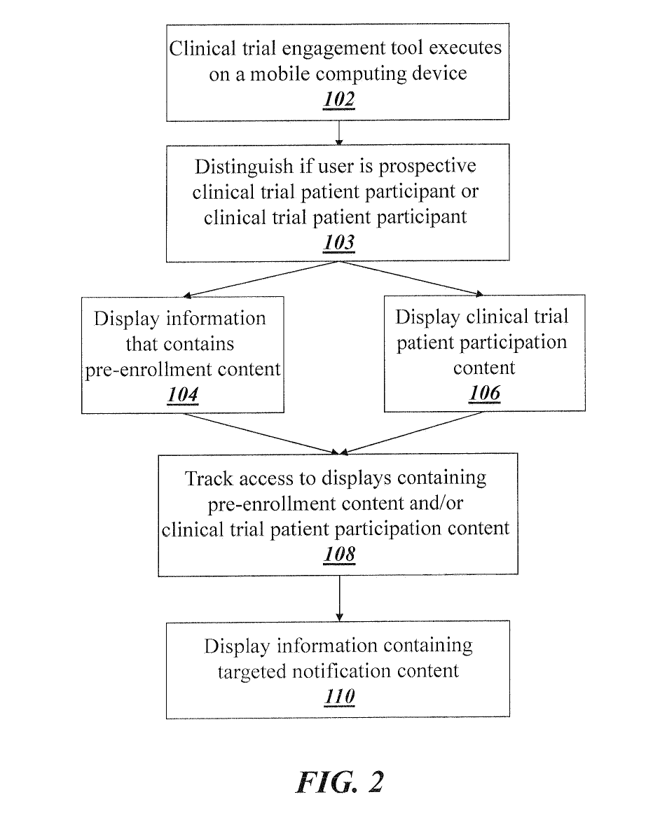

FIG. 2 depicts a flow chart displaying the computer implemented steps for utilizing the clinical trial engagement tool 10. In step 102, the clinical trial engagement tool 10 executes on a mobile computing device 12 (e.g., as a mobile application). The clinical trial engagement tool 10 can distinguish or identify whether a user is a prospective clinical trial patient participant or clinical trial patient participant based on authentication/authorization or lack of authentication/authorization (step 103). For example, a user is recognized by the clinical trial engagement tool 10 as a clinical trial patient participant if they have logged-in or undergone some form of authentication and/or authorization process and is associated with a clinical trial as a clinical trial patient participant. Alternatively, a user is recognized by the clinical trial engagement tool 10 as a prospective clinical trial patient participant if they have not undergone such an authentication or authorization process and are not associated with a clinical trial or otherwise identified as a clinical trial participant. If the user is identified/recognized as a prospective clinical trial participant, the clinical trial engagement tool 10 displays information that contains pre-enrollment content (via pre-enrollment displays 14) (step 104). If the user is identified/recognized as a clinical trial participant, the clinical trial engagement tool 10 additionally displays clinical trial patient participation content (via clinical trial patient participation displays 16) (step 106). In step 108, pre-enrollment displays 14 and/or clinical trial patient participation displays 16 accessed by the user are tracked using the tracking mechanism 20 (step 108). The clinical trial engagement tool 10 displays information containing targeted notification content (via notification displays 22) (step 110).

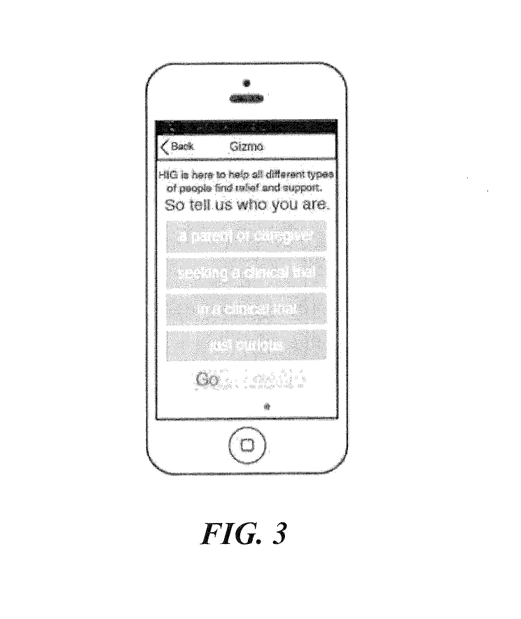

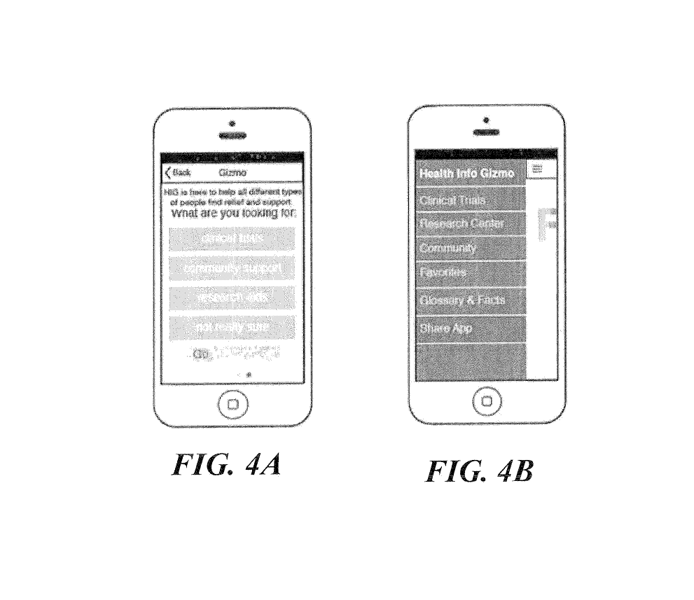

FIG. 3 depicts a starting menu display implemented by the clinical trial engagement tool 10 on a mobile computing device 12. This starting menu display particularly distinguishes between a user that is a prospective clinical trial patient participant or a clinical trial patient participant. For example, the menu requests the user select a category of who they are and/or what they are looking for: “a parent or caregiver”, “seeking a clinical trial” (i.e., prospective clinical trial patient participant), “in a clinical trial participant” (i.e., clinical trial patient participant), or “just curious.” In FIG. 4A, a mobile computing device 12 displays a menu of general information topics containing pre-enrollment content for a user that is a prospective clinical trial patient participant. These information topics can also be displayed to a user that is a clinical trial patient participant. In this example, the general information topics can include the following selectable options: “clinical trials”, “community support”, “research aids”, and “not really sure”. In another example, the clinical trial engagement tool 10 is implemented on a mobile computing device 12 such that when the mobile application begins or initiates, it displays an interesting fact prior to leading to a menu display as shown in FIG. 4B. For example, the interesting facts can include:
“Doctors Are Just Like Us: 88% of physicians surveyed use the Internet to research pharmaceutical, biotech, and medical devices.”
“Pew Research: 35% U.S. adults have gone online specifically to figure out what medical condition they or someone else might have.”
“Approximately 80% of adults who have participated in a clinical research study would consider doing so again.”
   Those of skill in the art will appreciate that the above examples are merely illustrative, and in no way limit the potential content that can be displayed in accordance with this feature.

The menu display of FIG. 4B, similar to FIG. 4A, loads a menu of information topics containing pre-enrollment content. For example, the information topics can include: “Clinical Trials”, “Research Center”, “Community”, “Favorites”, “Glossary & Facts”, and “Share App.” However, one of skill in the art will appreciate that the present invention is in no way limited to the particular layouts or options shown in the figures. The same or similar functionality is considered to form a part of likely implementations of the present invention.

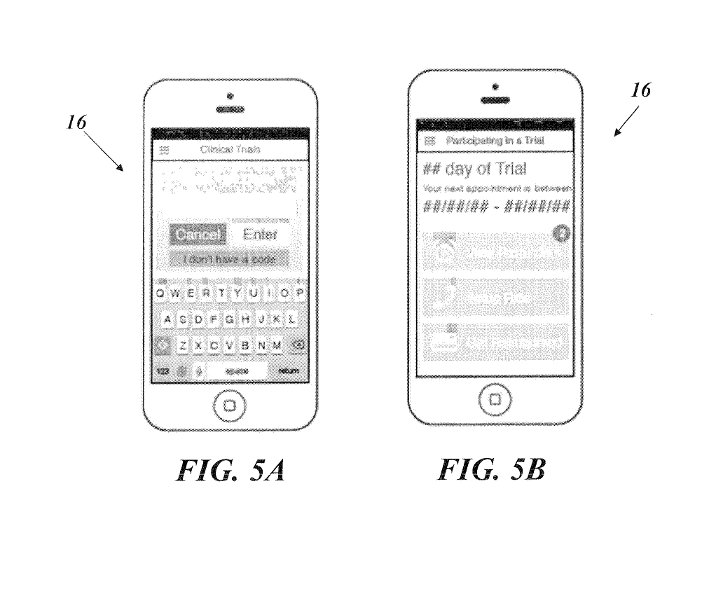

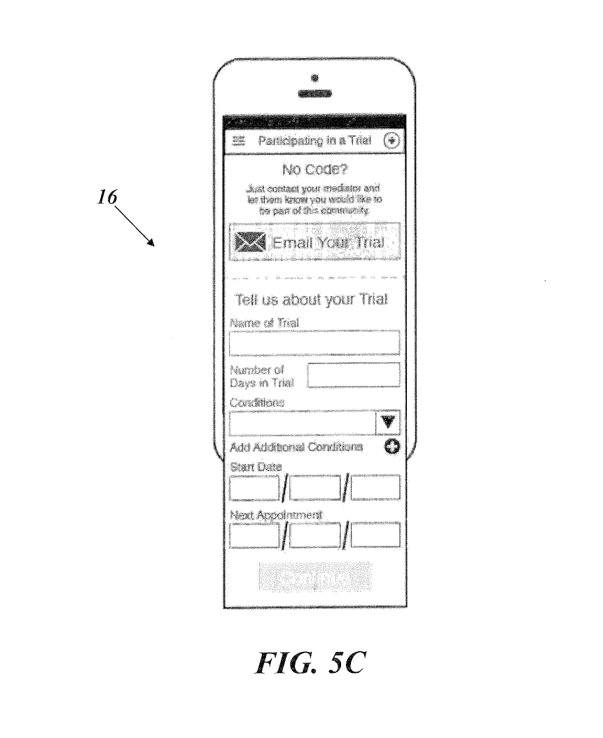

FIGS. 5A-5C depict clinical trial patient participation displays 16 and example content. In FIG. 5A, for example, a user is provided a clinical trial patient participation display 16 where they can enter a trial code (referencing a clinical trial) enabling the user (i.e., clinical trial patient participant) to access a particular clinical trial in which the user is enrolled. The entering of the trial code is part of an example authorization/authentication process for securely only allowing access to the clinical trial patient participation content for certain users. However, the present invention can make use of a number of different processes for authorization and authentication of a user, as would be appreciated by those of skill in the art.

In one example, clinical trial patient participation displays 16 containing information content related to guidelines for participation in a specific clinical trial within which the user is enrolled can be provided as shown in FIG. 5B. In this particular example, a menu display is provided to user showing number of days of a trial and scheduling of a next appointment. The example of FIG. 5B allows the user to select or obtain specific clinical trial patient participation content such as “View Reminders”, “Setup Ride”, or “Get Reimbursed.”

Thus, in this example, the clinical trial engagement tool 10 can be in communication with a clinical trial participant transportation system (via “Setup Ride”) and/or a clinical trial participant reimbursement system (via “Get Reimbursed”) to be made accessible to the users that are clinical trial patient participants. For example, a clinical trial participant transportation system can be integrated with the clinical trial engagement tool 10 to provide various transportation services to a clinical trial patient participant. In a further example, a clinical trial participant reimbursement system can be integrated with the clinical trial engagement tool 10 to provide various reimbursement capabilities for a clinical trial patient participant with respect to their financial transactions in a clinical trial.

FIG. 5C depicts a preliminary clinical trial patient participation display 16 for a user that does not remember (i.e., forgotten) or have access to a clinical trial code. In this example, a user (i.e., clinical trial patient participant) that does not have a clinical trial code can access their clinical trial information (utilizing the clinical trial engagement tool 10) by requesting a trial code via email. Alternatively, the user can provide specific information about trial such as “name of trial”, “conditions”, “start date”, and/or “next appointment” which is supplemented with authenticating/authorizing processes prior to the clinical trial engagement tool 10 providing access to the user.

This aspect of the clinical trial engagement tool 10 can provide other clinical trial patient participation displays 16 with content related to clinical trials in which the user is enrolled. Some examples of other clinical trial patient participation content can include: doctors or clinical researchers associated with a specific clinical trial, treatment protocols associated with a specific clinical trial, disease or condition management tools associated with a specific clinical trial, health records of the user associated with a specific clinical trial, calendar of events associated with a specific clinical trial, and medication reminders for the user associated with a specific clinical trial. The clinical trial patient participation content can be displayed such that a private communication mechanism enables the user associated with a specific clinical trial to communicate with either a clinical trial administrator, doctor, or care provider. Other examples of clinical trial patient participation content are included within the scope of the present invention as appreciated by one of skill in the art. The clinical trial patient participation content can include one or more of text, audio, still images, animation, video, or interactive formats.

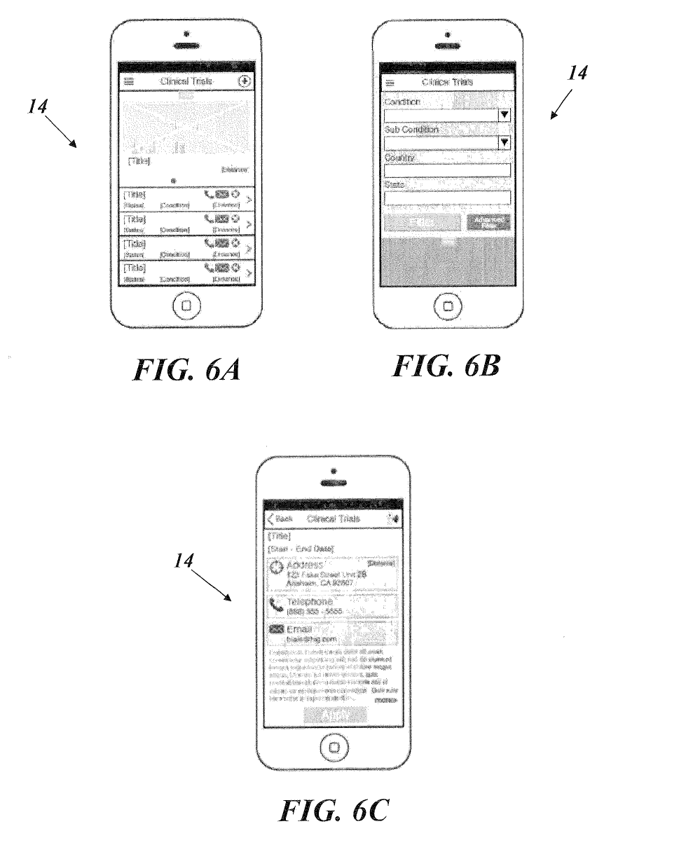

A prospective clinical trial patient participant can learn about clinical trials through pre-enrollment displays 14, illustrative examples of which are shown in FIGS. 6A-6C. FIG. 6A depicts a pre-enrollment display 14 including a menu list showing available clinical trials. As shown in FIG. 6A, for each clinical trial, the list includes the following clinical trial information: “Title”, “Status” (whether accepting clinical trial patient participants), “Condition” (e.g., type of disease), and “Distance” along with contact icons for a phone number or email tied to each clinical trial. For users looking for particular clinical trials based on certain criteria, a pre-enrollment display 14 provides search capabilities (as shown in FIG. 6B) to the user. These pre-enrollment displays 14 provide either regular searching or advanced searching capabilities regarding for example condition, sub-condition, state, age, distance, etc. Searches can be conducted within a proprietary network or database, or can be configured to occur anywhere on the Internet, World-Wide-Web, or the like. Once a user finds and selects a desirable clinical trial, a pre-enrollment display 14 showing clinical trial information is provided in FIG. 6C regarding a particular clinical trial. This pre-enrollment display 14 can include Start-End Date, Address, Phone Number, Email, Description of clinical trial, and a selectable button linked to application process for particular clinical trial. Again, the particular content of the pre-enrollment displays 14 can change as desired by a particular client or implementation, such that the present invention is by no means limited to the particular content described herein, as would be appreciated by those of skill in the art.

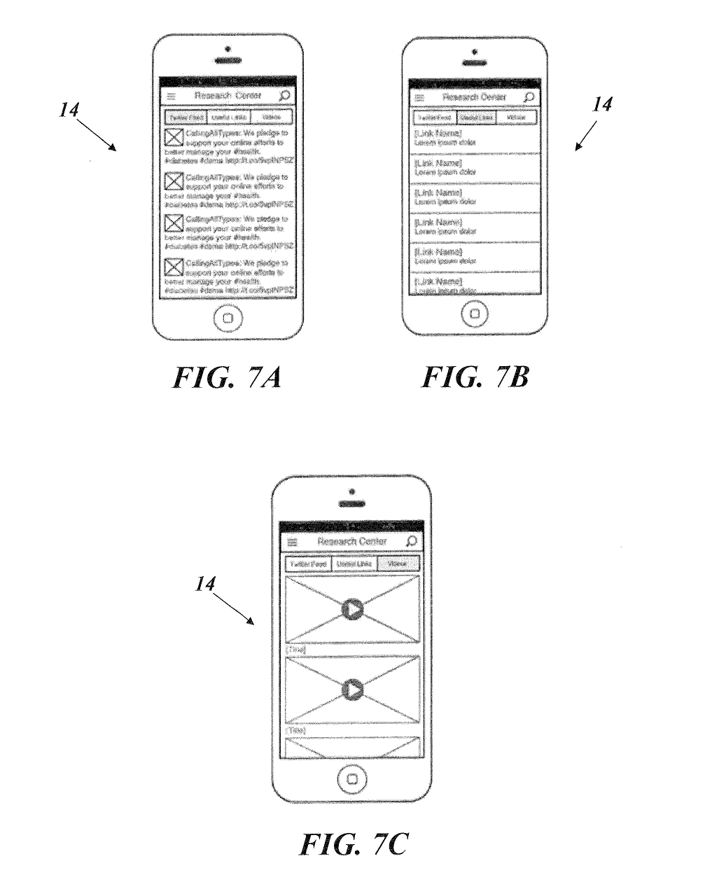

FIGS. 7A-7C depict pre-enrollment displays 14 in the form of illustrative mobile device displays having specific disease or condition research content. For example, pre-enrollment displays 14 can include information generally describing “research centers.” As shown in FIGS. 7A-7C, pre-enrollment displays 14 include three tabs (e.g., Twitter Feed, Useful Links, and Videos) that can provide information about research centers via different types of content.

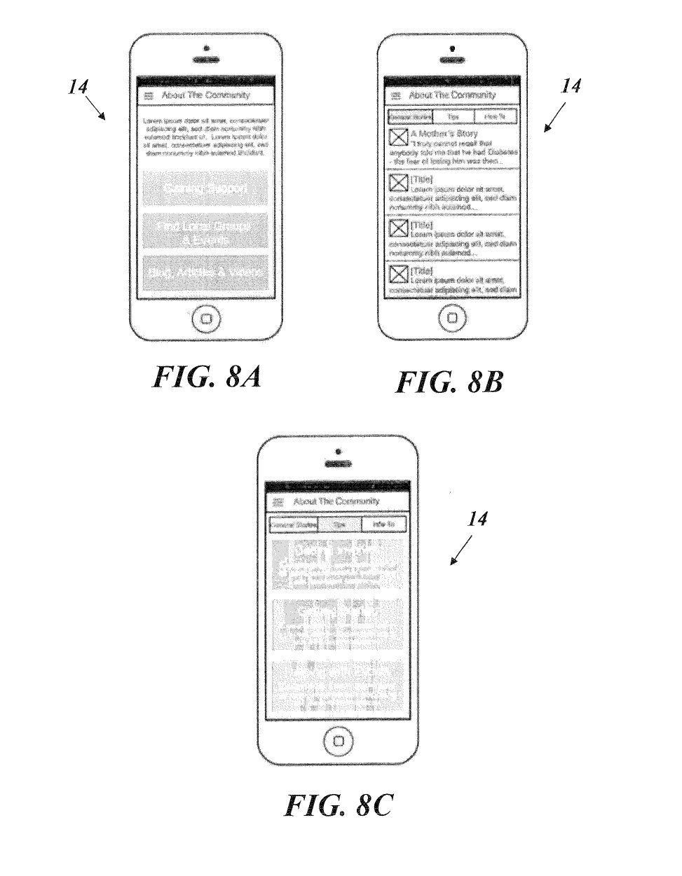

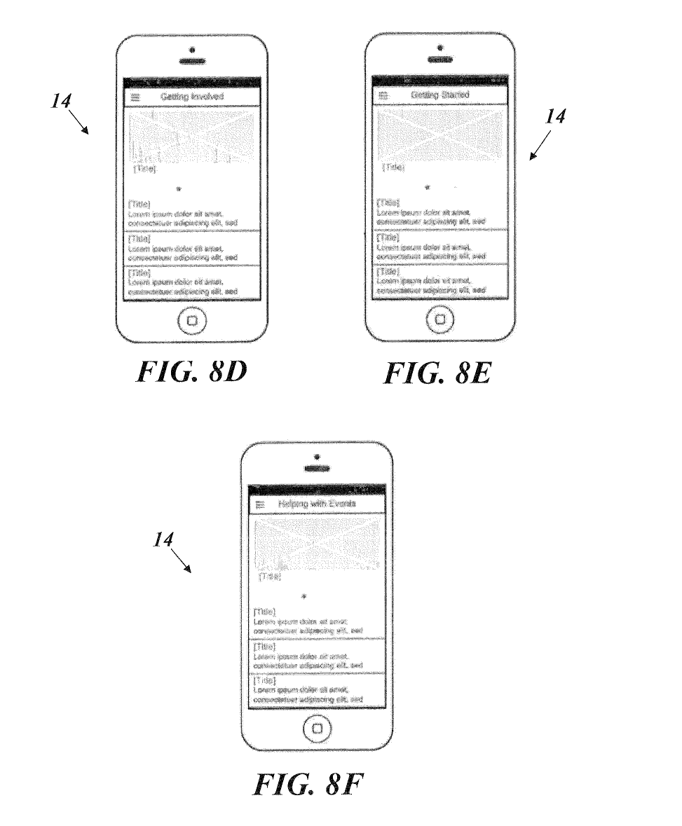

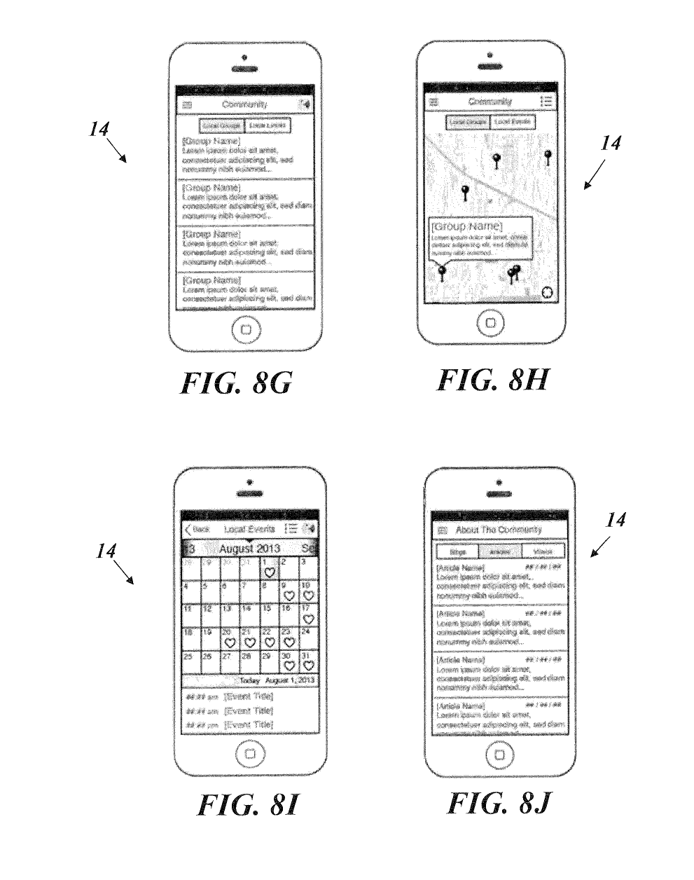

FIGS. 8A-8J depict pre-enrollment displays 14 in the form of illustrative mobile device displays containing content concerning disease or condition themed: community groups, organizations, events, social networks, and information. For example, an initial display can generally describe the purpose of the disease or condition themed community and three buttons (as shown in FIG. 8A) provide access to “gaining support”, “local groups & events”, and “blogs, articles, & videos.” This aspect of the clinical trial engagement tool 10 enables a user to read about disease or condition themed stories (shown in list of FIG. 8B), disease or condition themed tips (shown as selectable options: “Getting Involved”, “Getting Started”, and “Helping with Events” in FIG. 8C), and disease or condition themed information describing “how to” get involved in community (shown as tab option in FIGS. 8B-8C). Selecting any of the options in FIG. 8C provides list displays (shown in FIGS. 8D-8F) of in formation or content with respect to the topics of “Getting Involved”, “Getting Started”, and “Helping with Events.” This aspect of the clinical trial engagement tool 10 also enables a user to access and learn about local groups and local events as shown by the lists provided in the display of FIG. 8G. In particular, a map can be provided (as shown in FIG. 8H) to show user how close they are to these groups or events. Also, this feature can provide mobile device displays (i.e., pre-enrollment displays 14) showing local events in a calendar format as shown in FIG. 8I. This aspect of the clinical trial engagement tool 10 can further provide list displays with respect to Blogs, Articles, and Vides (shown in FIG. 8J) regarding the Community.

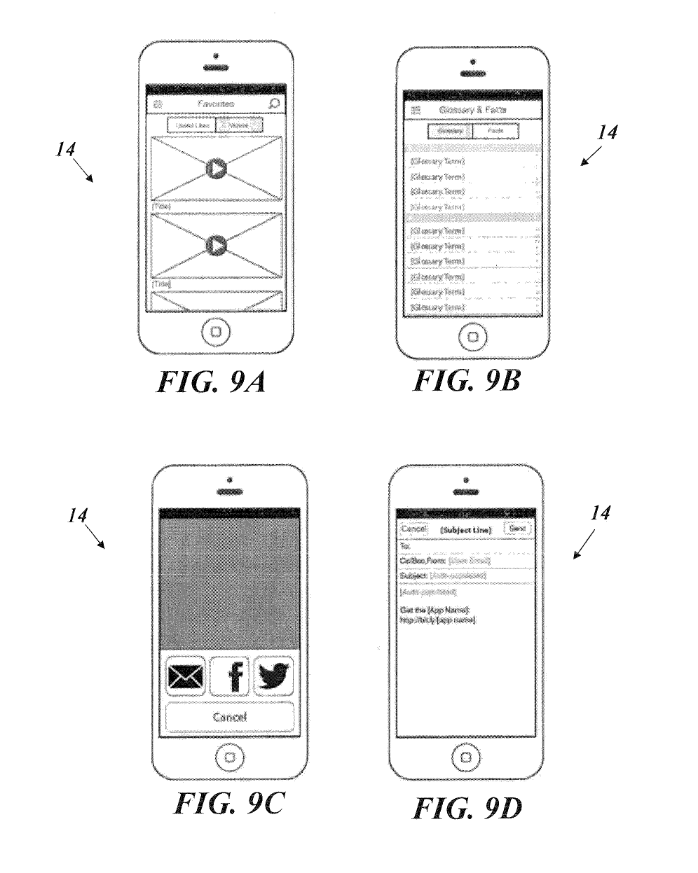

FIGS. 9A-9D depict pre-enrollment displays 14 in the form of displays about other user tools/features content. For example, using user preferences, the clinical trial engagement tool 10 can provide a list of favorite links and videos as shown in FIG. 9A. Also, the clinical trial engagement tool 10 can provide list displays of glossary terms and facts (shown in FIG. 9B) for the user to select and read. As shown in FIGS. 9C-9D, a user can share interesting information from pre-enrollment displays of the clinical trial engagement tool 10 with friends, family, co-workers, etc. via email, social network site (e.g., Facebook®), and Twitter®. This sharing feature, if used with clinical trial patient participation displays 16, can be restricted for clinical trial patient participation content such that a user cannot share certain private medical information as appreciated by one of skill in the art.

The clinical trial engagement tool 10 can provide other pre-enrollment displays 14. Some examples of other pre-enrollment content can include: available clinical trials, specific disease or condition research, disease or condition themed community groups, disease or condition themed organizations, disease or condition themed social networks, and a guide on formation of a new disease or condition themed group. Other examples of pre-enrollment content are included within the scope of the present invention as appreciated by one of skill in the art. As shown in FIGS. 6A-9D, the pre-enrollment content can include one or more of text, audio, still images, animation, video, or interactive formats.

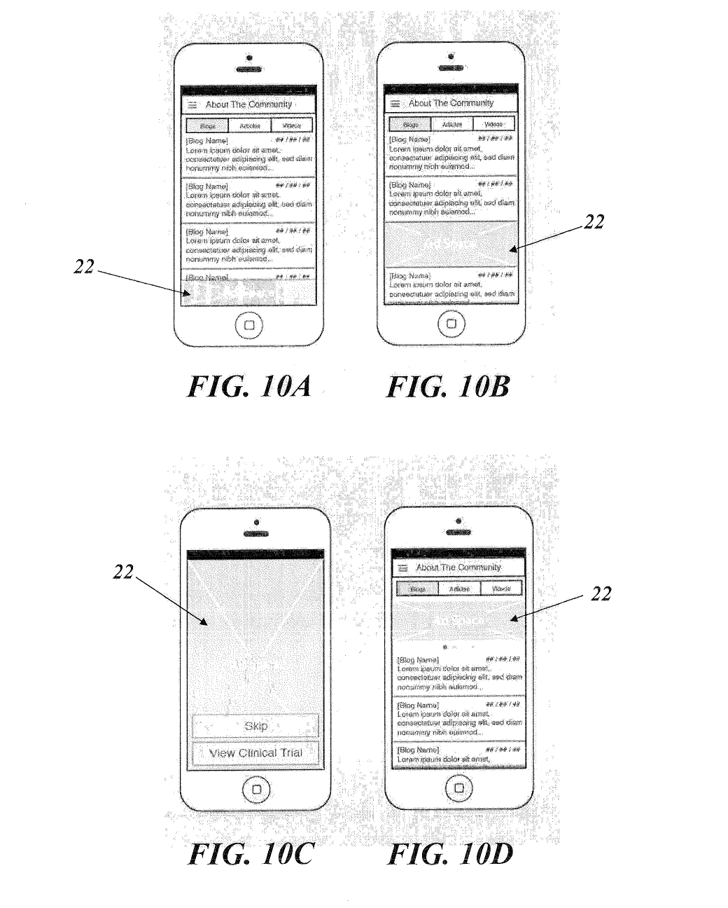

FIGS. 10A-10D depicts how notification displays 22 can be provided to a user. In this example, the notification displays 22 include advertising or marketing content. The notification displays 22 (noted as “Ad Space”) can be positioned in different places within a pre-enrollment display 14 (e.g., “About the Community” display). In this example, the advertising or marketing content (i.e., “Ad Space”) is provided within the pre-enrollment displays 14 such that it doesn't disrupt user's ability to view other content. The notification displays 22 are meant to provide content that the user has potential to be interested in based on the tracking mechanism. For example, upcoming clinical trials related to a particular disease of interest to a user (based on tracking information) can be provided in the advertising or marketing content. The notification displays 22 can additionally provide other notification functionality, as would be readily appreciated by those of skill in the art.

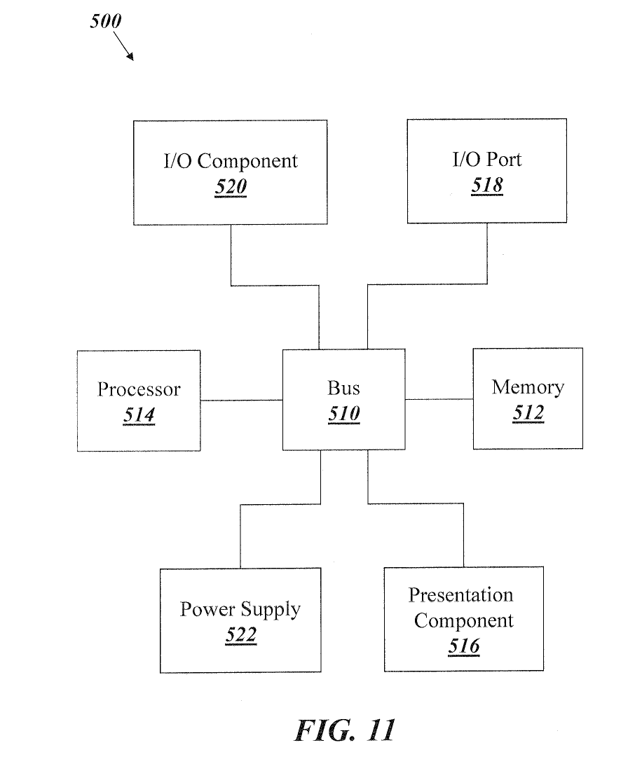

FIG. 11 illustrates an example of a computing device 500 which can provide computing or processing functionality for the clinical trial engagement tool 10 and any other processing functionality described herein and utilized in the implementation of aspects of the illustrative methods and systems of the present invention. The computing device 500 is merely an illustrative example of a suitable computing environment and in no way limits the scope of the present invention. A “computing device,” as represented by FIG. 11, can include a “workstation,” a “server,” a “laptop,” a “desktop,” a “hand-held device,” a “mobile device,” a “tablet computer,” or other computing devices, as would be understood by those of skill in the art. Given that the computing device 500 is depicted for illustrative purposes, embodiments of the present invention may utilize any number of computing devices 500 in any number of different ways to implement a single embodiment of the present invention. Accordingly, embodiments of the present invention are not limited to a single computing device 500, as would be appreciated by one with skill in the art, nor are they limited to a single type of implementation or configuration of the example computing device 500.

The computing device 500 can include a bus 510 that can be coupled to one or more of the following illustrative components, directly or indirectly: a memory 512, one or more processors 514, one or more presentation components 516, input/output ports 518, input/output components 520, and a power supply 522. One of skill in the art will appreciate that the bus 510 can include one or more busses, such as an address bus, a data bus, or any combination thereof. One of skill in the art additionally will appreciate that, depending on the intended applications and uses of a particular embodiment, multiple components can be implemented by a single device. Similarly, in some instances, a single component can be implemented by multiple devices. As such, FIG. 11 is merely illustrative of an exemplary computing device that can be used to implement one or more embodiments of the present invention, and in no way limits the invention.

The computing device 500 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 500.

The memory 512 can include computer-storage media in the form of volatile and/or nonvolatile memory. The memory 512 can be removable, non-removable, or any combination thereof. Exemplary hardware devices are devices such as hard drives, solid-state memory, optical-disc drives, and the like. The computing device 500 can include one or more processors 514 that read data from components such as the memory 512, the various I/O components 520, etc. Presentation component(s) 516 present data indications to a user or other device. Exemplary presentation components 516 include a display device, speaker, printing component, vibrating component, etc. The I/O ports 518 can allow the computing device 500 to be logically coupled to other devices, such as I/O components 520. Some of the I/O components 520 can be built into the computing device 500. Examples of such I/O components 520 include a microphone, joystick, recording device, game pad, satellite dish, scanner, printer, wireless device, Bluetooth® device, networking device, native phone features, and the like.

One of skill in the art will appreciate a wide variety of ways to modify and alter the tool and method of FIGS. 1-11, as well as the various components with which it interacts. For example, the one or more computing systems can be implemented according to any number of suitable computing system structures. Furthermore, some or all of the information contained in the one or more data sources alternatively can be stored in one or more remote databases (e.g., cloud computing infrastructure such as cloud databases, virtual databases, and any other remote database).

In some embodiments, it may be desirable to implement the method and tool using multiple iterations of the depicted modules, controllers, and/or other components, as would be appreciated by one of skill in the art. Furthermore, while some modules and components are depicted as included within the system, it should be understood that, in fact, any of the depicted modules alternatively can be excluded from the system and included in a different system. One of skill in the art will appreciate a variety of other ways to expand, reduce, or otherwise modify the system upon reading the present specification.

To any extent utilized herein, the terms “comprises” and “comprising” are intended to be construed as being inclusive, not exclusive. To any extent utilized herein, the terms “exemplary”, “example”, and “illustrative”, are intended to mean “serving as an example, instance, or illustration” and should not be construed as indicating, or not indicating, a preferred or advantageous configuration relative to other configurations. To any extent utilized herein, the terms “about” and “approximately” are intended to cover variations that may existing in the upper and lower limits of the ranges of subjective or objective values, such as variations in properties, parameters, sizes, and dimensions. In one non-limiting example, the terms “about” and “approximately” mean at, or plus 10 percent or less, or minus 10 percent or less. In one non-limiting example, the terms “about” and “approximately” mean sufficiently close to be deemed by one of skill in the art in the relevant field to be included. To any extent utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A clinical trial engagement tool configured for execution on a mobile computing device and configured for interaction with a user, the clinical trial engagement tool comprising:
a plurality of displays of information containing pre-enrollment content, wherein access to the plurality of displays of information containing pre-enrollment content is enabled without requirement of a user-specific login or security key and pre-enrollment content is based on searches executed on the mobile computing device;
a plurality of displays containing clinical trial patient participation content, wherein access to the plurality of displays containing clinical trial patient participation content is enabled only upon completion of a user authentication process and completion of a user authorization process;
a tracking mechanism using a processor and generating data that tracks which of the plurality of displays containing pre-enrollment content are accessed by the mobile computing device;
a plurality of displays of information containing notification content, wherein the notification content is automatically selected for display, using a processor, based on the data that tracks which of the plurality of displays of information containing pre-enrollment content are accessed by the mobile computing device, thereby transforming the data into parameters that define which of the plurality of displays of information containing the notification content are automatically selected for display;
wherein the notification content comprises information related to upcoming clinical trials having a potential to be of interest to the user of the mobile computing device, wherein the potential to be of interest is determined based on which of the plurality of displays containing pre-enrollment content are tracked as having been accessed by the mobile computing device.

2. The tool of claim 1, wherein the tracking mechanism generates the data that tracks which of the plurality of displays containing clinical trial patient participation content are accessed using the mobile computing device.

3. The tool of claim 2, wherein the notification content is automatically selected for display based on the data tracking which of the plurality of displays of information containing clinical trial patient participation content are accessed using the mobile computing device.

4. The tool of claim 1, wherein the plurality of displays of information containing pre-enrollment content comprise one or more displays of information content related to available clinical trials.

5. The tool of claim 1, wherein the plurality of displays of information containing pre-enrollment content comprise one or more displays of information content related to specific disease or condition research.

6. The tool of claim 1, wherein the plurality of displays of information containing pre-enrollment content comprise one or more displays of information content related to one or more disease or condition themed community groups.

7. The tool of claim 1, wherein the plurality of displays of information containing pre-enrollment content comprise one or more displays of information content related to one or more disease or condition themed organizations.

8. The tool of claim 1, wherein the plurality of displays of information containing pre-enrollment content comprise one or more displays of information content related to one or more disease or condition themed social networks.

9. The tool of claim 1, wherein the plurality of displays of information containing pre-enrollment content comprise one or more displays of information content related to a guide on formation of a new disease or condition themed group.

10. The tool of claim 1, wherein the plurality of displays containing clinical trial patient participation content comprise one or more displays of information content related to guidelines for participation in a specific clinical trial within which the user is enrolled.

11. The tool of claim 1, wherein the plurality of displays containing clinical trial patient participation content comprise one or more displays of information content related to one or more doctors or clinical researchers associated with a specific clinical trial within which the user is enrolled.

12. The tool of claim 1, wherein the plurality of displays containing clinical trial patient participation content comprise one or more displays of information content related to one or more treatment protocols associated with a specific clinical trial within which the user is enrolled.

13. The tool of claim 1, wherein the plurality of displays containing clinical trial patient participation content comprise one or more displays of information content related to one or more disease or condition management tools associated with a specific clinical trial within which the user is enrolled.

14. The tool of claim 1, wherein the plurality of displays containing clinical trial patient participation content comprise one or more displays of information content related to one or more health records of the user associated with a specific clinical trial within which the user is enrolled.

15. The tool of claim 1, wherein the plurality of displays containing clinical trial patient participation content comprise one or more displays of information content related to a calendar of events associated with a specific clinical trial within which the user is enrolled.

16. The tool of claim 1, wherein the plurality of displays containing clinical trial patient participation content comprise one or more displays of information content related to one or more medication reminders for the user associated with a specific clinical trial within which the user is enrolled.

17. The tool of claim 1, wherein the plurality of displays containing clinical trial patient participation content comprise one or more displays of information content related to a private communication mechanism enabling the user associated with a specific clinical trial within which the user is enrolled to communicate with one or more clinical trial administrator, doctor, or care provider.

18. The tool of claim 1, wherein the plurality of displays containing clinical trial patient participation content comprise one or more displays of information content related to a clinical trial participant transportation system or a clinical trial participant reimbursement system.

19. The tool of claim 1, wherein the tracking mechanism is implemented by the mobile computing device.

20. The tool of claim 1, wherein the tracking mechanism is implemented on a cloud computing infrastructure in communication with the mobile computing device.

21. The tool of claim 1, wherein the notification content automatically selected for display based on the data tracking which of the plurality of displays of information containing pre-enrollment content are accessed using the mobile computing device is determined by an advertising or marketing algorithm.

22. The tool of claim 1, wherein the pre-enrollment content comprises one or more of text, audio, still images, animation, video or interactive formats.

23. The tool of claim 1, wherein the clinical trial patient participation content comprises one or more of text, audio, still images, animation, video or interactive formats.

24. The tool of claim 1, wherein the notification content further comprises targeted advertising or marketing content.

25. A method of using a clinical trial engagement tool to interact with a user such that the clinical trial engagement tool is configured for execution on a mobile computing device, the method comprising the steps of:
the clinical trial engagement tool executing on the mobile computing device;
the clinical trial engagement tool displaying one or more of a plurality of displays of information containing pre-enrollment content, wherein access to the plurality of displays of information containing pre-enrollment content is enabled without requirement of a user-specific login or security key and pre-enrollment content is based on searches executed on the mobile computing device;
the clinical trial engagement tool displaying a plurality of displays containing clinical trial patient participation content, wherein access to the plurality of displays containing clinical trial patient participation content is enabled only upon completion of a user authentication process and completion of a user authorization process;
a tracking mechanism using a processor and generating data tracking which of the plurality of displays containing pre-enrollment content are accessed using the mobile computing device;
the clinical trial engagement tool transforming the data into parameters that define which of the plurality of displays of information containing notification content should be automatically selected, and then automatically selecting, using a processor, targeted notification content based on the data tracking which of the plurality of displays of information containing pre-enrollment content are accessed using the mobile computing device; and
the clinical trial engagement tool displaying a plurality of displays of information containing the targeted notification content;
wherein the targeted notification content comprises information related to upcoming clinical trials having a potential to be of interest to a user of the mobile computing device, wherein the potential to be of interest is determined based on which of the plurality of displays containing pre-enrollment content are tracked as having been accessed by the mobile computing device.
